(19) United States
(12) Patent Application Publication
(10) Pub. No.: US 2026/0321742 A1
(43) Pub. Date: Oct. 15, 2026

(54) AQUEOUS ZINC SECONDARY BATTERY WITH MIXED CONDUCTIVE PROTECTIVE LAYER AND METHOD OF MANUFACTURING SAME

(71) Applicant: DONG-A UNIVERSITY RESEARCH FOUNDATION FOR INDUSTRY-ACADEMY COOPERATION, Busan (KR)

(72) Inventors: Min Su GU, Busan (KR); Su Hyun PARK, Busan (KR)

(21) Appl. No.: 19/639,062

(22) Filed: Apr. 3, 2026

(30) Foreign Application Priority Data
Apr. 11, 2025 (KR) 10-2025-0047461

(51) Int. Cl. H01M 10/42; H01M 4/36; H01M 4/38; H01M 10/28

(52) U.S. Cl. CPC H01M 10/4235; H01M 4/366; H01M 4/38; H01M 10/28

(57) ABSTRACT

Proposed are an aqueous zinc secondary battery to which a mixed conductive protective layer is applied, and a method of manufacturing the same. More particularly, proposed is a method of manufacturing an aqueous zinc secondary battery to which a mixed conductive protective layer is applied, wherein the aqueous zinc secondary battery includes a zinc negative electrode having a first surface coated with a mixed conductive protective layer including a plurality of bilayers composed of a poly(diallyldimethylammonium chloride) (PDDA) layer having ionic conductivity and a poly(3,4-ethylenedioxythiophene):polystyrenesulfonate (PEDOT:PSS) layer having electronic conductivity, a positive electrode facing the zinc negative electrode and spaced apart therefrom, a separator disposed between the zinc negative electrode and the positive electrode to prevent a short circuit therebetween, and an electrolyte serving as a medium through which ions move between the zinc negative electrode and the positive electrode.

### ACKNOWLEDGMENT OF GOVERNMENT SUPPORT

This invention was supported by the Korea Institute of Energy Technology Evaluation and Planning (KETEP) and the Ministry of Trade, Industry & Energy (MOTIE) of the Republic of Korea (RS-2022-KP002702). This research was also supported by Global-Learning & Academic research institution for Master's.PhD students, and Postdocs (G-LAMP) Program of the National Research Foundation of Korea (NRF) grant funded by the MOE (RS-2025-25440216).

### CROSS REFERENCE TO RELATED APPLICATION

The present application claims priority to Korean Patent Application No. 10-2025-0047461, filed Apr. 11, 2025, the entire contents of which are incorporated herein for all purposes by this reference.

### BACKGROUND

### 1. Technical Field

The present disclosure relates to an aqueous zinc secondary battery having improved cycle stability and electrochemical performance by coating a zinc negative electrode with a protective layer exhibiting mixed ionic and electronic conductivity, and to a method of manufacturing the same.

### 2. Description of the Related Art

Typically, aqueous zinc secondary batteries have attracted significant attention as next-generation energy storage systems due to the abundance of zinc resources and the inherent stability of aqueous electrolytes.

However, conventional aqueous zinc secondary batteries suffer from problems in that the direct contact between a zinc negative electrode and an aqueous electrolyte causes dendrite growth and side reactions (corrosion and hydrogen evolution) as charge-discharge reactions proceed, thereby significantly deteriorating cycle life.

Accordingly, in order to overcome the limitation in cycle life of aqueous zinc secondary batteries, there is an urgent need to develop surface modification technologies capable of preventing direct contact between zinc metal and an aqueous electrolyte while simultaneously enabling smooth ionic and electronic conductivity as well as high mechanical strength.

### DOCUMENTS OF RELATED ART

### Patent Documents

(Patent Document 1) Korean Patent No. 10-2649623
(Patent Document 2) Korean Patent No. 10-2539660

### SUMMARY

The present disclosure, which has been devised to address the problems described above, aims to provide a method of manufacturing an aqueous zinc secondary battery to which a mixed conductive protective layer is applied.

The present disclosure also aims to provide an aqueous zinc secondary battery to which the mixed conductive protective layer is applied.

Objectives of the present disclosure are not limited to those mentioned above, and other objectives not mentioned will be clearly understood by those skilled in the art from the following description.

According to one aspect of the present disclosure for achieving the objectives described above, provided is a method of manufacturing an aqueous zinc secondary battery to which a mixed conductive protective layer is applied, wherein the aqueous zinc secondary battery includes: a zinc negative electrode having a first surface coated with a mixed conductive protective layer including a plurality of bilayers composed of a poly(diallyldimethylammonium chloride) (PDDA) layer having ionic conductivity and a poly(3,4-ethylenedioxythiophene):polystyrenesulfonate (PEDOT:PSS) layer having electronic conductivity; a positive electrode facing the zinc negative electrode and spaced apart therefrom; a separator disposed between the zinc negative electrode and the positive electrode to prevent a short circuit therebetween; and an electrolyte serving as a medium through which ions move between the zinc negative electrode and the positive electrode, wherein manufacturing the zinc negative electrode includes: pretreating a zinc negative electrode substrate; and forming, on a first surface of the pretreated zinc negative electrode substrate, a mixed conductive protective layer including a plurality of bilayers composed of a PDDA layer having ionic conductivity, and a PEDOT:PSS layer having electronic conductivity by a layer-by-layer (LbL) self-assembly coating method using a PDDA aqueous solution and a PEDOT:PSS aqueous solution.

According to another aspect of the present disclosure, provided is an aqueous zinc secondary battery to which a mixed conductive protective layer is applied, the aqueous zinc secondary battery including: a zinc negative electrode; a positive electrode facing the zinc negative electrode and spaced apart therefrom; a separator disposed between the zinc negative electrode and the positive electrode to prevent a short circuit therebetween; and an electrolyte serving as a medium through which ions move between the zinc negative electrode and the positive electrode, wherein the zinc negative electrode includes: a zinc negative electrode substrate; and a mixed conductive protective layer formed on a first surface of the zinc negative electrode substrate, the mixed conductive protective layer including a plurality of bilayers composed of a PDDA layer having ionic conductivity and a PEDOT:PSS layer having electronic conductivity.

In the present disclosure, a method of manufacturing an aqueous zinc secondary battery to which a mixed conductive protective layer is applied can implement a multilayer uniform surface coating exhibiting mixed ionic and electronic conductivity by an LbL self-assembly coating method.

In the present disclosure, an aqueous zinc secondary battery to which a mixed conductive protective layer is applied can suppress dendrite growth and side reactions such as corrosion and hydrogen evolution.

Additionally, in the present disclosure, the aqueous zinc secondary battery to which the mixed conductive protective layer is applied can exhibit enhanced cycle stability and suppress dendrites while simultaneously improving the diffusion of ions and electrons beyond overcoming limitations of simple physical barriers.

Effects of the present disclosure are not limited to those mentioned above, and other effects not mentioned will be clearly understood by those skilled in the art from the following description.

### BRIEF DESCRIPTION OF THE DRAWINGS

FIG. 1 is a flowchart of a zinc negative electrode preparation step in a method of manufacturing an aqueous zinc secondary battery to which a mixed conductive protective layer is applied, according to an embodiment of the present disclosure;

FIGS. 2A, 2B, and 2C show results of a comparison of cycle stability, a comparison of rate capability, and a comparison before and after potentiostatic polarization, respectively, for Example 1 and Comparative Example 1 according to an embodiment of the present disclosure;

FIG. 2D shows results of a comparison of charge-discharge curves and a comparison of cycle performance for Example 2 and Comparative Example 2 according to an embodiment of the present disclosure;

FIGS. 3A, 3B, 3C, and 3D show results of a chronoamperometry (CA) test, a comparison of Arrhenius plots and activation energy for desolvation, double-layer capacitance measurement, and nucleation overpotential (NOP) analysis, respectively, for Example 1 and Comparative Example 1 according to an embodiment of the present disclosure;

FIGS. 4A and 4B show results of a comparison of charge transfer resistance during a 72-hour storage test and scanning electron microscopy/X-ray diffraction (SEM/XRD) analysis after the storage test, respectively, for Example 1 and Comparative Example 1 according to an embodiment of the present disclosure;

FIGS. 5A and 5B show results of linear sweep voltammetry (LSV) and Tafel analysis for Example 3 and Comparative Example 3 according to an embodiment of the present disclosure;

FIG. 6 shows results of in-situ observation of electrochemical deposition behavior and surface morphology imaging after deposition for Example 4 and Comparative Example 4 according to an embodiment of the present disclosure; and

FIG. 7 is a schematic diagram of a reaction illustrating a difference in zinc deposition behavior with or without the application of a mixed conductive protective layer formed by an LbL self-assembly coating method in an aqueous zinc secondary battery.

### DETAILED DESCRIPTION

The advantages and characteristics of the present disclosure and methods for achieving those will become clear with reference to the following embodiments described in detail in conjunction with the attached drawings. However, the present disclosure is not limited to the embodiments set forth below and will be implemented in many different forms. The following embodiments are provided only to completely disclose the present disclosure and inform those skilled in the art to which the present disclosure pertains of the scope of the present disclosure. In the meantime, the terms used herein are for describing the embodiments and are not intended to limit the present disclosure. As used herein, the singular forms are intended to include the plural forms, unless otherwise mentioned.

The present disclosure relates to an aqueous zinc secondary battery to which a mixed conductive protective layer is applied, the aqueous zinc secondary battery being capable of enhancing the diffusion of ions and electrons during charge discharge processes and effectively suppressing dendrite growth by establishing LbL self-assembly coating conditions for coating the surface of a zinc negative electrode substrate with PDDA and PEDOT:PSS, and to a method of manufacturing the same.

Hereinafter, the aqueous zinc secondary battery to which the mixed conductive protective layer is applied and the method of manufacturing the same, according to a preferred embodiment of the present disclosure, will be described in detail with reference to the attached drawings.

The method of manufacturing the aqueous zinc secondary battery to which the mixed conductive protective layer is applied, according to an embodiment of the present disclosure, may be configured by including a zinc negative electrode preparation step, a positive electrode preparation step, a separator preparation step, an electrolyte preparation step, and a secondary battery assembly step.

In this case, except for the zinc negative electrode preparation step, a characteristic step of the present disclosure, the positive electrode preparation step, the separator preparation step, the electrolyte preparation step, and the secondary battery assembly step are applicable in the same manner as corresponding steps of conventional methods of manufacturing aqueous zinc secondary batteries, and thus a detailed description thereof will be omitted.

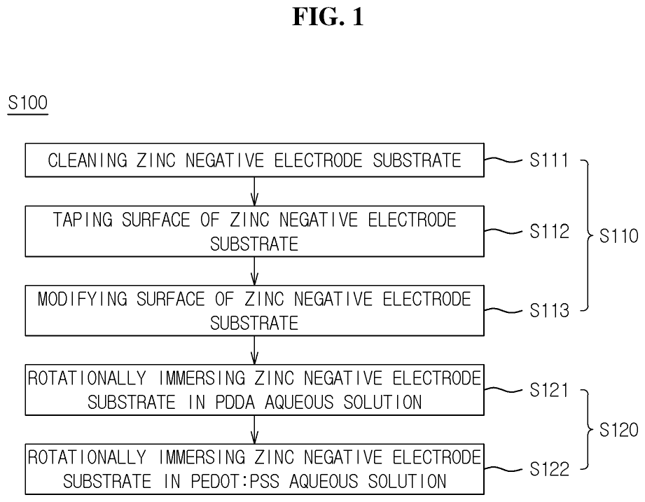

As illustrated in FIG. 1, the zinc negative electrode preparation step (S100) may include a pretreatment step (S110) in which a zinc negative electrode substrate is pretreated, and a mixed conductive protective layer formation step (S120) in which a mixed conductive protective layer including a plurality of bilayers composed of a PDDA layer, which is an ionically conductive polymer layer, and a PEDOT:PSS layer, which is an electronically conductive polymer layer, is formed on a first surface of the pretreated zinc negative electrode substrate by an LbL self-assembly coating method using a PDDA aqueous solution and a PEDOT:PSS aqueous solution.

When a zinc negative electrode is coated physically and electrochemically with an inorganic protective layer, particle-like structures are formed and often exhibit thick and non-uniform morphologies. This leads to hindered ion transport, low electrical conductivity, and increased tortuosity, thereby limiting the performance of zinc metal batteries (ZMBs). ZMBs with high energy density require efficient transport of ions and electrons as well as mechanical strength. Thus, a polymer-based organic layer having ionically and electronically conductive functional groups, as well as mechanical flexibility, can be used as the protective layer for the zinc negative electrode.

However, polymers inherently have low mechanical strength and thus have limitations as a stable interfacial coating when used as a single-component system. Hence, in the present disclosure, a bilayer structure in which the first surface of the zinc negative electrode is coated alternately with the PDDA layer and the PEDOT:PSS layer is applied to implement a more stable interface. In addition, since complex synthesis processes and difficulties in large-area processing hinder practical application, an LbL self-assembly coating method capable of easily forming a uniform nanoscale multilayer thin film by utilizing intermolecular interactions such as electrostatic interaction and hydrogen bonding is used to enable large-area fabrication.

Accordingly, in the zinc negative electrode preparation step of the present disclosure, the mixed conductive protective layer formed on the first surface of the zinc negative electrode substrate is formed by the LbL self-assembly coating method, and includes a plurality of bilayers composed of the PDDA layer being cationic and having ionic conductivity and the PEDOT:PSS layer being anionic and having electronic conductivity.

The PDDA aqueous solution and the PEDOT:PSS aqueous solution used in the LbL self-assembly coating are cationic and anionic polyelectrolyte solutions, respectively, and may have concentrations of 1 mg/mL or more and 5 mg/mL or less.

The PDDA aqueous solution and the PEDOT:PSS aqueous solution may have weight-average molecular weights (Mw) in the range of 200,000 to 350,000 and in the range of 50,000 to 100,000, respectively, and may contain 20 wt % of PDDA and 1.1 wt % of PEDOT:PSS in water, respectively.

Furthermore, each of the PDDA and PEDOT:PSS aqueous solutions may contain 0.10 M or less of sodium chloride.

The pretreatment step (S110) may include a cleaning step (S111), a taping step (S112), and a surface modification step (S113) in which the first surface of the taped zinc negative electrode substrate is treated with oxygen plasma.

Hereinafter, each of the steps will be described in detail according to the processing sequence.

The zinc negative electrode substrate is ultrasonically cleaned in acetone, ethanol, and deionized water for 10 minutes each using a JAC-3010 ultrasonic cleaner manufactured by Kodo (S111).

After ultrasonically cleaning the zinc negative electrode substrate, the surface thereof may be dried at room temperature naturally or by using compressed air.

After drying the zinc negative electrode substrate, a second surface of the zinc negative electrode substrate is taped by attaching a polyimide (PI) film tape thereto, such that the protective layer is formed only on the first surface of the zinc negative electrode substrate (S112).

Thereafter, to provide a negative surface charge to the surface of the zinc negative electrode substrate and promote subsequent adsorption of a polyelectrolyte during the coating process, the zinc negative electrode substrate is placed in a plasma cleaner (PDC-32G-2, HARRICK PLASMA) and then treated with oxygen plasma for 10 minutes for surface modification (S113). Accordingly, the surface charge and polarity of the zinc negative electrode substrate are enhanced, thereby enabling effective LbL self-assembly coating.

According to the pretreatment step (S110), the second surface of the zinc negative electrode substrate is taped, while the first surface is subjected to surface modification to have a negative surface charge.

The mixed conductive protective layer formation step (S120), following the pretreatment step (S110), may include a PDDA aqueous solution rotational immersion step (S121) in which the zinc negative electrode substrate is rotationally immersed in the PDDA aqueous solution by the LbL self-assembly coating method, and a PEDOT:PSS aqueous solution rotational immersion step (S122) in which the zinc negative electrode substrate is rotationally immersed in the PEDOT:PSS aqueous solution.

In this case, the mixed conductive protective layer formation step (S120) may be performed by the LbL self-assembly coating method, in which the mixed conductive protective layer is formed by repeatedly performing rotational immersion and withdrawal processes on the material to be coated.

The mixed conductive protective layer formation step (S120) may be performed using an automatic dip-coating machine capable of coating the coating material in multiple layers.

The rotational immersion may be performed at a rotational speed of less than 2,000 rpm (S121 and S122).

To coat the zinc negative electrode substrate having the negative surface charge with the polymer layer being cationic and having ionic conductivity, the zinc negative electrode substrate having the negative surface charge is rotationally immersed in the PDDA aqueous solution. Additionally, to coat the zinc negative electrode substrate, which has been coated with the cationic polymer, with the polymer layer being anionic and having electronic conductivity, the zinc negative electrode substrate coated with the cationic polymer is rotationally immersed in the PEDOT:PSS aqueous solution (S121 and S122).

More specifically, in the PDDA aqueous solution rotational immersion step (S121), the zinc negative electrode substrate having the negative surface charge is rotationally immersed in the PDDA aqueous solution to coat the surface of the zinc negative electrode substrate with the PDDA layer, the polymer layer being cationic and having ionic conductivity. Then, the zinc negative electrode substrate is rotationally immersed in deionized water for rinsing to remove uncoated PDDA.

Preferably, in this case, the zinc negative electrode substrate is rotationally immersed in the PDDA aqueous solution for 10 minutes. In addition, the rinsing time for removing uncoated PDDA is preferably 1 minute for each case, depending on the number of deionized water baths for rinsing, and the number of deionized water baths is preferably 3.

Thereafter, in the PEDOT:PSS aqueous solution rotational immersion step (S122), the zinc negative electrode substrate is rotationally immersed in the PEDOT:PSS aqueous solution to coat the surface of the zinc negative electrode substrate with the PEDOT:PSS layer, the polymer layer being anionic and having electronic conductivity. Then, the zinc negative electrode substrate is rotationally immersed in deionized water for rinsing to remove uncoated PEDOT:PSS.

Preferably, in this case, the zinc negative electrode substrate is rotationally immersed in the PEDOT:PSS aqueous solution for 10 minutes. In addition, the rinsing time for removing uncoated PEDOT:PSS is preferably 1 minute for each case, depending on the number of deionized water baths for rinsing, and the number of deionized water baths is preferably 3.

As described above, by repeatedly performing multiple cycles of rotationally immersing the zinc negative electrode substrate alternately, the mixed conductive protective layer composed of the plurality of bilayers may be formed on the first surface of the zinc negative electrode substrate.

In addition, to stabilize the multilayer structure, the zinc negative electrode coated with the protective layer may be dried at room temperature. Then, the PI film tape, which has been attached to the second surface of the zinc negative electrode coated with the protective layer, may be removed so that the zinc negative electrode can be applied to the aqueous zinc secondary battery.

An aqueous zinc secondary battery to which a mixed conductive protective layer is applied, according to another embodiment of the present disclosure, may be configured by including: a zinc negative electrode; a positive electrode facing the zinc negative electrode and spaced apart therefrom; a separator disposed between the zinc negative electrode and the positive electrode to prevent a short circuit therebetween; and an electrolyte serving as a medium through which ions move between the zinc negative electrode and the positive electrode,

In this case, except for the zinc negative electrode, which is a characteristic component of the present disclosure, the positive electrode, the separator, and the electrolyte may be configured in the same manner as corresponding components of conventional aqueous zinc secondary batteries, and thus a detailed description thereof will be omitted.

The zinc negative electrode includes: a zinc negative electrode substrate; and a mixed conductive protective layer formed on a first surface of the zinc negative electrode substrate, the mixed conductive protective layer including a plurality of bilayers composed of a PDDA layer, which is a polymer layer having ion conductivity, and a PEDOT:PSS layer.

Each bilayer may have a thickness in the range of 1 to 100 nm.

The mixed conductive protective layer may have 5 to 10 bilayers.

The mixed conductive protective layer may be composed of a fibrous polymer and may have a uniform porous surface.

The aqueous zinc secondary battery to which the mixed conductive protective layer formed through the process described above is applied can suppress dendrite growth and side reactions. In addition, the aqueous zinc secondary battery to which the mixed conductive protective layer formed through the process described above is applied exhibits enhanced ionic and electronic conductivity compared to those without the mixed conductive protective layer under the same conditions.

In embodiments of the present disclosure, the PDDA layer is spontaneously assembled by being alternately adsorbed on the surface of the zinc negative electrode with the PEDOT:PSS layer, thereby preventing unnecessary aggregation and improving interlayer adhesion.

In embodiments of the present disclosure, the positive electrodes of a symmetric cell and a full cell fabricated to test electrochemical performance contain zinc and manganese dioxide (MnO₂), respectively.

The symmetric cell, according to an embodiment of the present disclosure, may maintain a voltage range of −0.02 to +0.02 V relative to a reference voltage in a cycle performance test for up to 1800 hours.

The full cell, according to an embodiment of the present disclosure, may have a capacity retention rate of greater than 66.1% and not exceeding 81.8% of an initial areal capacity after 100 cycles in a cycle performance test, and a capacity retention rate of greater than 53.9% and not exceeding 71.1% of the initial areal capacity after 200 cycles.

The positive electrode containing manganese dioxide may be a dry electrode fabricated by roll-pressing a mixture composed of β-manganese dioxide nanoparticle powder, conductive carbon, and polytetrafluoroethylene in a mass ratio of 70:25:5. The β-manganese dioxide nanoparticle powder may be prepared by ball-milling zirconia balls and β-manganese dioxide powder in a mass ratio of 10:1. Alternatively, the β-manganese dioxide nanoparticle powder may be subjected to high-energy ball milling at a speed of 200 rpm for 3 hours.

Hereinafter, the present disclosure will be described in more detail through specific examples, comparative examples, and experimental examples. The following examples, comparative examples, and experimental examples are merely provided to aid understanding of the present disclosure, and the scope of the present disclosure is not limited thereto.

### Example 1

Manufacture of Aqueous Zinc Secondary Battery to which Mixed Conductive Protective Layer is Applied (1)

An aqueous zinc secondary battery was manufactured in a 2032 coin-type symmetric cell configuration. A zinc electrode, a Whatman GF/C 1822-150 glass fiber separator, and a 2 M zinc sulfate aqueous electrolyte were used. The electrode was manufactured to have a diameter of 14 mm and a thickness of 0.05 mm. Since this cell was symmetric, the positive and negative electrodes had the same material and structure. Through the zinc negative electrode preparation step, a characteristic step of the present disclosure, a mixed conductive protective layer was formed on a first surface of a zinc negative electrode substrate by an LbL self-assembly coating method using an automatic dip-coating machine. A PDDA aqueous solution having a concentration of 1 mg/mL and a PEDOT:PSS aqueous solution having a concentration of 5 mg/mL and containing 0.01 M sodium chloride served as aqueous solutions for LbL self-assembly coating. The first surface of the zinc negative electrode substrate was coated with the mixed conductive protective layer including 5 bilayers by repeatedly performing a process of rotationally immersing the zinc negative electrode substrate alternately in the PDDA aqueous solution and the PEDOT:PSS aqueous solution five times. A zinc negative electrode coated with the mixed conductive protective layer including 5 bilayers was prepared by the method described above and applied, thereby manufacturing the aqueous zinc secondary battery.

### Example 2

Manufacture of Aqueous Zinc Secondary Battery to which Mixed Conductive Protective Layer is Applied (2)

Unlike Example 1, an aqueous zinc secondary battery was manufactured in a 2032 coin-type full cell configuration. A zinc negative electrode, a manganese dioxide dry positive electrode, a Whatman GF/C 1822-150 glass fiber separator, and an aqueous electrolyte in which 2 M zinc sulfate and 0.4 M manganese sulfate were mixed were used. The zinc negative electrode coated with a mixed conductive protective layer including 5 bilayers was prepared by the method described above and applied, thereby manufacturing the aqueous zinc secondary battery.

### Example 3

### Manufacture of Three-Electrode Electrochemical Cell

To evaluate electrochemical properties depending on the presence or absence of a mixed conductive protective layer, a cell for electrochemical measurement having a three-electrode configuration was fabricated. A zinc negative electrode coated with a mixed conductive protective layer including 5 bilayers was prepared through the zinc negative electrode preparation step, a characteristic step of the present disclosure, and served as both a working electrode and a counter electrode. Additionally, a saturated calomel electrode (SCE) served as a reference electrode, and a 1 M sodium sulfate aqueous solution served as an electrolyte, thereby fabricating the three-electrode electrochemical cell.

### Example 4

### Manufacture of Observation Cell

An observation cell enabling in-situ optical analysis was fabricated by horizontally placing a zinc electrode coated with a mixed conductive protective layer including 5 bilayers between two slide glasses, sealing the edges with an insulating tape, and then injecting a 2 M ZnSO₄ electrolyte for in-situ optical microscopy.

### Comparative Example 1

Unlike Example 1, an aqueous zinc secondary battery was manufactured by applying a zinc electrode without a mixed conductive protective layer. The aqueous zinc secondary battery was manufactured in a 2032 coin-type symmetric cell configuration. A zinc electrode, a Whatman GF/C 1822-150 glass fiber separator, and a 2 M zinc sulfate aqueous electrolyte were used. The electrode was manufactured to have a diameter of 14 mm and a thickness of 0.05 mm. Since this cell was symmetric, the positive and negative electrodes had the same material and structure.

### Comparative Example 2

Unlike Example 2, an aqueous zinc secondary battery was manufactured by applying a zinc electrode without a mixed conductive protective layer. The aqueous zinc secondary battery was manufactured in a 2032 coin-type full cell configuration. The aqueous zinc secondary battery was composed of a zinc negative electrode, a manganese dioxide dry positive electrode, a Whatman GF/C 1822-150 glass fiber separator, and an aqueous electrolyte in which 2 M zinc sulfate and 0.4 M manganese sulfate were mixed.

### Comparative Example 3

Unlike Example 3, a three-electrode electrochemical cell was manufactured by applying a zinc electrode without a mixed conductive protective layer. An SCE served as a reference electrode, and a 1 M sodium sulfate aqueous solution served as an electrolyte, thereby fabricating the three-electrode electrochemical cell.

### Comparative Example 4

Unlike Example 4, an observation cell enabling in-situ optical analysis was fabricated by horizontally placing a zinc electrode without a mixed conductive protective layer between two slide glasses, sealing the edges with an insulating tape, and then injecting a 2 M ZnSO₄ electrolyte for in-situ optical microscopy.

Comparison of Cycle Performance and Interfacial Stability of Aqueous Zinc Secondary Batteries with or without Application of Mixed Conductive Protective Layer

To evaluate the cycle performance of the aqueous zinc secondary batteries depending on the presence or absence of the mixed conductive protective layer with which the zinc negative electrode was coated, a galvanostatic cycling test was performed on the fabricated symmetric cells of Example 1 and Comparative Example 1 and on the full cells of Example 2 and Comparative Example 2.

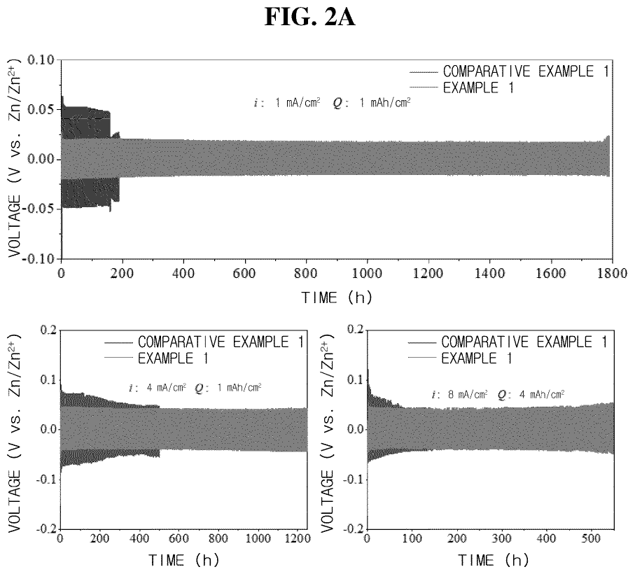

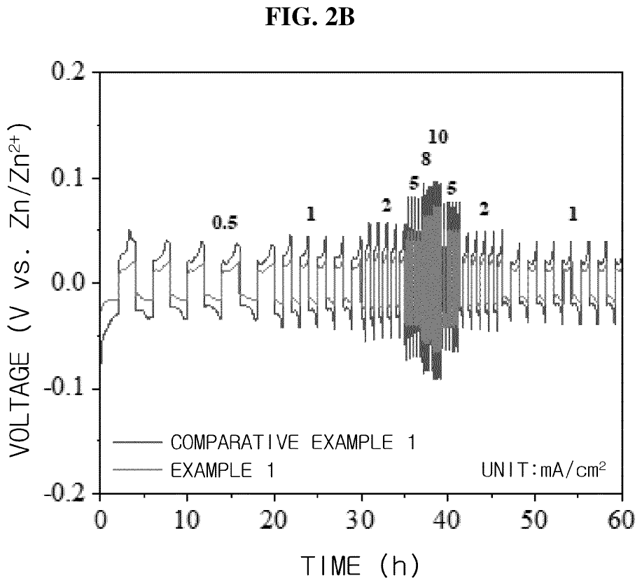

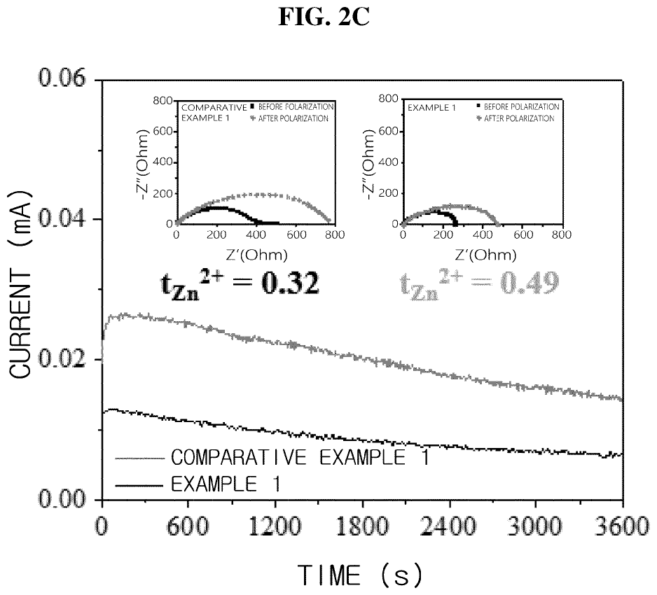

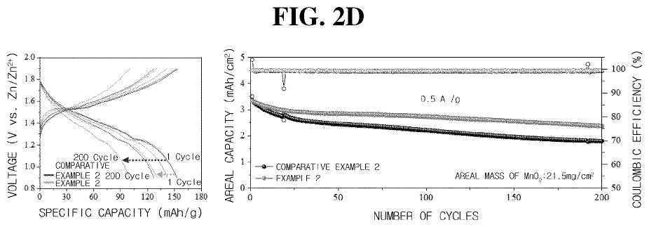

The cycle stability comparison results of the symmetric cells of Example 1 and Comparative Example 1 are shown in FIG. 2A. Referring to FIG. 2A, the cycle test result of Comparative Example 1 showed a cycle life of 170 hours at a current density of 1 mA/cm² and an areal capacity of 1 mAh/cm². On the other hand, Example 1 showed a cycle life of 1800 hours (75 days) under the same current density and areal capacity, and exhibited stable performance without changes in overpotential within a voltage range of −0.025 to 0.025 V. As a result of performing the cycle test by changing the current density to 4 mA/cm² and 8 mA/cm², Example 1 showed stable cycle lives of 1200 hours and 500 hours, respectively, demonstrating cycle stability that is at least five times higher than that of Comparative Example 1, which failed to exhibit stable cycle lives even for 200 hours and 100 hours, respectively. Typically, when the current density is high, zinc ions are rapidly depleted at the interface between the electrode and the electrolyte during charge discharge processes, thereby promoting dendrite formation and the accumulation of inactive zinc on the electrode surface. This leads to a shortened cycle life. From these results, it is confirmed that coating the zinc negative electrode with the mixed conductive protective layer secures a stable interface.

The rate capability of Example 1 and Comparative Example 1 was evaluated by changing the current density range from 0.5 to 10 mA/cm². The results thereof are shown in FIG. 2B. Referring to FIG. 2B, Example 1 maintained a stable voltage profile even under high current density conditions and exhibited uniform interfacial reaction behavior with suppressed dendrite growth. On the other hand, it was confirmed that Comparative Example 1 exhibited a voltage profile distributed over a broader range than that of Example 1. From these results, it is seen that the mixed conductive protective layer induces a uniform flux of zinc ions and an even distribution of the electric field, thereby promoting an improved electrodeposition reaction rate and thus contributing to uniform zinc plating and the maintenance of interfacial stability. These results demonstrate that the aqueous zinc secondary battery to which the mixed conductive protective layer is applied can have excellent electrochemical performance even under high-rate charge discharge conditions.

In addition, after applying a constant potential of 15 mV to the symmetric cells of Example 1 and Comparative Example 1 for 3600 seconds (potentiostatic polarization), a CA test and electrochemical impedance spectroscopy (EIS) were performed. The results thereof are also shown in FIG. 2C. The state immediately after the application of the constant potential was defined as an initial state, and the state after the current was stabilized was defined as a steady state.

By inducing plating and stripping behavior for a long time at a low overpotential, plating stability and changes in electrochemical resistance depending on the presence or absence of the mixed conductive protective layer can be confirmed.

The analysis results of the current-time curves obtained from the CA test showed that Comparative Example 1 exhibited an initial current of 0.0175 mA or less, followed by a pattern of rapid decay up to 1800 seconds and then a constant current. Example 1 exhibited an initial current of approximately 0.025 mA, which is higher than that of Comparative Example 1, followed by a pattern of gradual decay over time. When comparing the initial currents of Example 1 and Comparative Example 1, it is seen that Example 1, to which the mixed conductive protective layer was applied, has a lower charge transfer resistance, indicating that Example 1 exhibits higher interfacial reactivity. In addition, when comparing the slopes of the current decay of Example 1 and Comparative Example 1, the initial slope was greater in Comparative Example 1, indicating that the current of Example 1 decays more slowly over time. Accordingly, in Example 1, it is confirmed that zinc ion transport is continuously facilitated, and that concentration polarization and resistance increase at the interface are effectively suppressed.

As a result of interpreting the graphs obtained by performing EIS, Comparative Example 1 exhibited a typical semicircular pattern, indicating a high charge transfer resistance, and a charge transfer resistance of approximately 800Ω before polarization, but exhibited a distorted semicircle and a charge transfer resistance of approximately 400Ω after polarization. Although partial activation of the surface after polarization is observed, non-uniformity still remains.

On the other hand, in Example 1, compared with Comparative Example 1, the semicircle size was smaller and more uniform both before and after polarization, and low charge transfer resistances of 500Ω or less and 300 £2 or less were observed, respectively. Additionally, the semicircular pattern, which shows no significant change before and after polarization, confirms that interfacial stability is maintained.

The zinc ion transference number (t_{Zn}²⁺) was calculated using the CA test and EIS results.

$${t}_{{Zn}^{2}} = \frac{{I}_{S} ( Δ V - {I}_{0} {R}_{0} )}{{I}_{0} ( Δ V - {I}_{S} {R}_{S} )}$$

Herein, ΔV denotes the applied voltage of 15 mV, I₀ denotes the initial current, I_{S} denotes the steady-state current, R₀ denotes the initial electrode resistance, and R_{S} denotes the steady-state electrode resistance.

The calculation results showed that the zinc ion transference number was 0.32 in Comparative Example 1 and 0.49 in Example 1, confirming that zinc ions were more active in Example 1. Such results can be interpreted as a synergistic effect in which the positively charged quaternary ammonium group of PDDA interacts with the strongly polar functional group of PEDOT:PSS, thereby suppressing interactions with the electrolyte and sulfate ions at the electrode surface and promoting selective transport of zinc ions.

The comparison results of charge-discharge curves and cycle performance of Example 2 and Comparative Example 2 for further investigating the practical applicability to ZMBs are shown in FIG. 2D. A galvanostatic cycler was used, and cycling was performed under a constant current mode within a voltage range of 0.9 to 1.9 V. The areal mass of MnO₂ used for the positive electrode was 21.5 mg/cm².

Referring to FIG. 2D, during charge-discharge cycling from Cycle 1 to Cycle 200, it was confirmed that the specific capacity of Comparative Example 2 decreased by up to 54 mAh/g, whereas the specific capacity of Example 2 decreased by up to 24 mAh/g.

In addition, Comparative Example 2 exhibited performance degradation after 25 cycles and retained only 66.1% of the initial areal capacity. On the other hand, Example 2 retained 81.8% of the initial areal capacity even after 100 cycles. This is attributed to the enhanced interfacial stability of the zinc negative electrode resulting from the mixed conductive protective layer. After long-term cycling for 200 cycles, Comparative Example 2 retained 53.9% of the areal capacity, whereas Example 2 retained 71.1% of the areal capacity. Such results may indicate that the interfacial stability of the zinc negative electrode coated with the protective layer has significant potential in zinc metal-based energy storage systems. The symmetry in the charge-discharge curves and the Coulombic efficiency (%) over 200 cycles also confirm the high practical applicability to ZMBs.

From the above results, it is seen that applying the mixed conductive protective layer to the aqueous zinc secondary battery combines the effects of selective transport of zinc ions, enhanced electronic charge transfer, and physical/chemical suppression of interactions with water molecules and sulfate ions. These combined effects efficiently promote plating and stripping processes in the aqueous zinc secondary battery, thereby enhancing performance and cycle life.

Analysis of Ion Diffusion, Interfacial Properties, and Initial Deposition Reactivity of Aqueous Zinc Secondary Batteries with or without Application of Mixed Conductive Protective Layer

To evaluate the cycle performance of the aqueous zinc secondary batteries depending on the presence or absence of the mixed conductive protective layer with which the zinc negative electrode was coated, the following electrochemical analyses were performed on the fabricated symmetric cells of Example 1 and Comparative Example 1: a CA test, a comparison of Arrhenius plots and activation energy for desolvation, double-layer capacitance measurement, and NOP analysis.

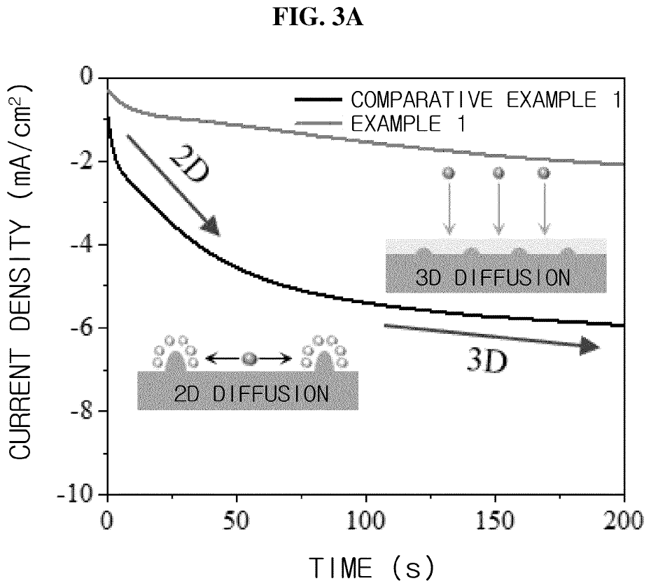

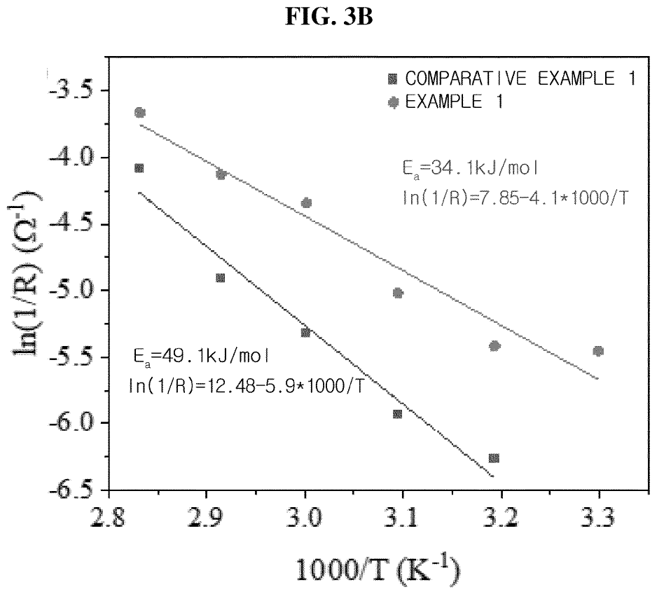

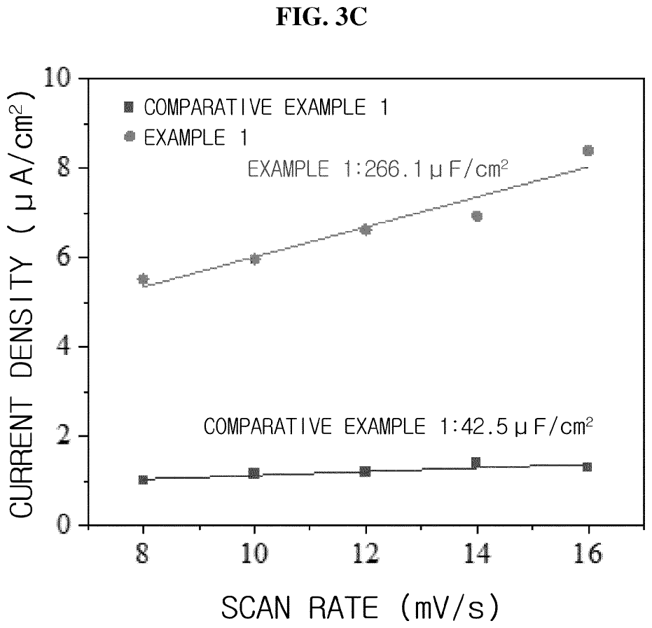

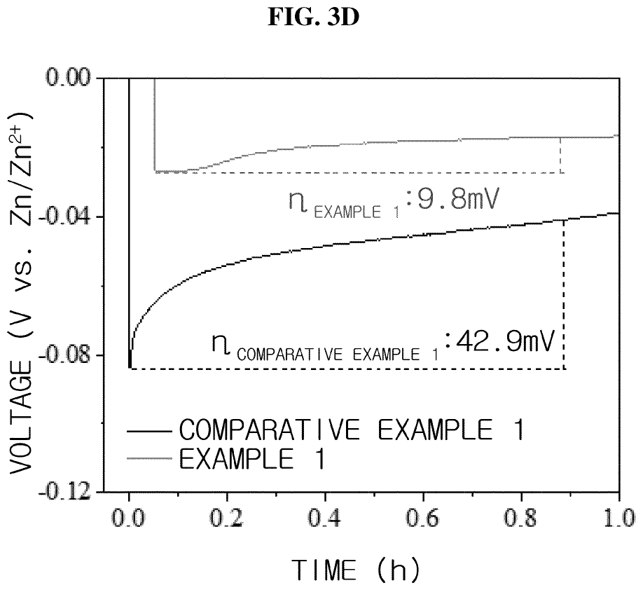

In electrochemical reactions, the diffusion behavior of zinc ions directly affects the growth morphology of zinc metal. The results of the CA test performed at an overpotential of −150 m V to evaluate ion diffusion behavior are shown in FIG. 3A. Referring to FIG. 3A, Comparative Example 1 exhibited a rapid increase in current density up to 60 seconds, followed by a three-dimensional (3D) diffusion behavior after 60 seconds. On the other hand, in Example 1, a transition from two-dimensional (2D) diffusion to 3D diffusion was observed within 25 seconds. Such results indicate that the mixed conductive protective layer promoted ion diffusion. It is also seen that the ion flux can be controlled by adjusting the thickness of the mixed conductive protective layer, in other words, by controlling the number of bilayers.

To evaluate the activation energy for desolvation, the diffusion energy barrier for zinc ions crossing the electrode/electrolyte interface was derived based on the Arrhenius relationship. To this end, the charge transfer resistance (R_{ct}) values measured under temperature conditions ranging from 30° C. to 78° C. (303 K to 351 K based on the absolute temperature T; corresponding to a 1000/T range of approximately 3.30 to 2.85 K⁻¹) were used. The activation energy for desolvation (Eₐ) was calculated based on the Arrhenius equation below. The results thereof are shown in FIG. 3B.

$$ln {R}_{ct}^{- 1} = ln A - \frac{{E}_{a}}{RT}$$

In this case, R_{ct}, A, Eₐ, R, and T denote the charge transfer resistance, pre-exponential factor, activation energy for zinc ion desolvation, gas constant, and temperature, respectively.

The calculation results showed that the activation energy of Comparative Example 1 was 49.1 kJ/mol, whereas the activation energy of Example 1 was 34.1 kJ/mol. Such a difference can be interpreted as being attributed to the thiophene and sulfonate groups present in PEDOT:PSS, which provide attractive interactions with zinc ions, and to the quaternary ammonium group of PDDA, which repels hydrated water molecules, thereby facilitating the desolvation process.

In addition, the double-layer capacitances of Comparative Example 1 and Example 1 were measured. The results thereof are shown in FIG. 3C. The double-layer capacitance was calculated based on the relationship between the capacitive current (i_{c}) measured by cyclic voltammetry (CV) and the scan rate. The capacitive current follows the equation below

$${i}_{c} = \frac{dq}{dt} = \frac{d ( C ∅ )}{dt} = C \frac{d ∅}{dt} + ∅ \frac{dC}{dt}$$

In the above equation, the capacitance was assumed to remain constant over time during the experiment and not to vary due to external conditions. Accordingly,

$$\frac{dc}{dt} = 0 ,$$

and the capacitive current is expressed by a simplified relation i_{c}=C·v, indicating that the capacitive current is proportional to the scan rate.

From the linear relationship between the capacitive current and the scan rate, that is, from the slope, the capacitance (C) can be obtained. The current value was set as the average of the forward and reverse currents at

$$0 V ( {i}_{c} = \frac{{i}_{0 {v}^{+}} - {i}_{0 {v}^{-}}}{2} ) .$$

For Example 1 and Comparative Example 1 of the present disclosure, the capacitive current was measured at varying scan rates of 8, 10, 12, 14, and 16 mV/s, and the capacitive current was expressed as a current density (μA/cm²) normalized with respect to the electrode area. Accordingly, the double-layer capacitance per unit area (Cal, unit: μF/cm²) was calculated from the slope of the linear relationship between the current density and the scan rate.

Referring to FIG. 3C, the double-layer capacitance calculated from the slope of the current density versus scan rate for Example 1 was 266.1 μF/cm², which is 6.26 times higher than 42.5 μF/cm², the double-layer capacitance of Comparative Example 1. Such an increase in capacitance indicates that PEDOT:PSS within the mixed conductive protective layer forms a 3D conductive network exhibiting excellent electronic and ionic conductivity, and that various polar functional groups strongly interact with zinc ions, thereby increasing the local concentration of zinc ions involved in redox activation.

The NOP comparison results for Example 1 and Comparative Example 1 are shown in FIG. 3D. By measuring the voltage change over time, the electrochemical properties at the initial stage of zinc metal deposition were analyzed. During the initial deposition process, the voltage rapidly decreases, reaching a minimum voltage (Vₘᵢₙ) at a specific time point, followed by a gradual increase to a steady voltage (V_{steady}).

The NOP represents the initial energy barrier required for zinc ions to form nuclei on the electrode surface, and can be calculated as the absolute value of the difference between the minimum voltage and the steady voltage. A lower overpotential indicates smoother and more uniform metal deposition.

As shown in FIG. 3D, the zinc negative electrode of Comparative Example 1 exhibited a high overpotential of 42.9 mV, whereas the zinc negative electrode of Example 1 exhibited a significantly lower overpotential of 9.8 mV. This difference can be interpreted as resulting from the mixed conductive protective layer promoting the electron transfer and nucleation process of zinc ions, thereby significantly lowering the energy barrier required for the initial deposition reaction. Therefore, the aqueous zinc secondary battery to which the mixed conductive protective layer is applied, according to the present disclosure, can not only simultaneously enhance the transport of ions and electrons but also induce more uniform and smoother zinc deposition on the electrode surface, thereby improving the efficiency of the initial electrochemical reaction.

Long-Term Storage Stability and Corrosion Suppression Effect of Zinc Electrodes with or without Application of Mixed Conductive Protective Layer

To evaluate the effect of suppressing side reactions and long-term storage stability depending on the presence or absence of the mixed conductive polymer protective layer, the symmetric cells of Example 1 and Comparative Example 1 were fabricated, followed by a storage test and electrochemical analysis.

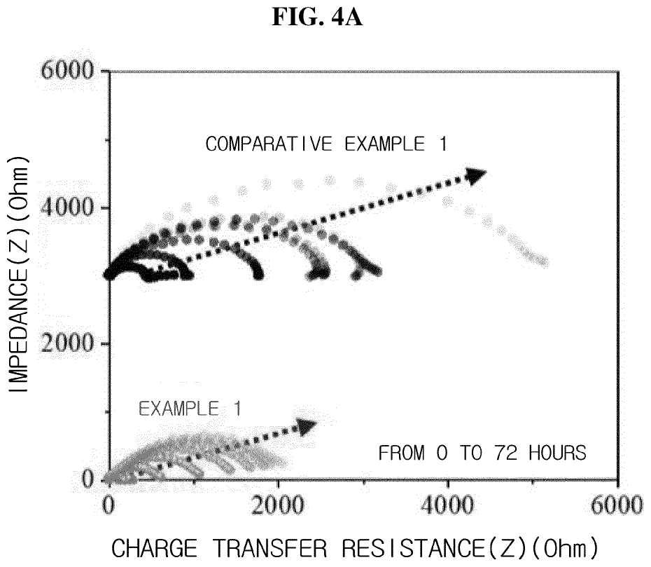

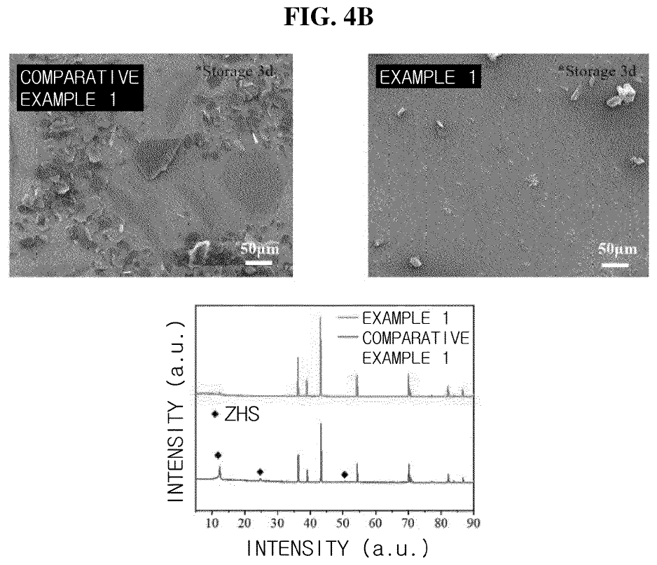

During the 72-hour storage test of Example 1 and Comparative Example 1, the charge transfer resistance was compared and analyzed by EIS. The results thereof are shown in FIG. 4A.

Referring to FIG. 4A, in Comparative Example 1, the charge transfer resistance (Ra) sharply increased from 400Ω to 5072Ω. On the other hand, Example 1, to which the mixed conductive protective layer was applied, exhibited an R_{ct} of 2023Ω. Such results can demonstrate the effectiveness of the mixed conductive protective layer in facilitating charge transfer through surface stabilization, that is, smooth transport of ions and electrons.

To analyze the corrosion behavior of the surface of the zinc negative electrode after the storage test, the symmetric cells of Example 1 and Comparative Example 1 were disassembled. SEM and XRD analyses were performed on the zinc negative electrodes of Example 1 and Comparative Example 1. The results thereof are also shown in FIG. 4B.

The SEM analysis results showed that continuous growth of zinc hydroxide sulfate (ZHS) due to corrosion was observed on the surface of the zinc negative electrode of Comparative Example 1. On the other hand, although some ZHS was observed partially on the zinc negative electrode of Example 1, an overall uniform surface was confirmed.

The XRD analysis results showed that the zinc negative electrode of Comparative Example 1 exhibited prominent characteristic peaks corresponding to ZHS byproducts within the ranges of 10 to 15, 20 to 30, and 50 to 60 a.u. On the other hand, in the zinc negative electrode of Example 1, the intensity of the characteristic peaks was confirmed to be significantly reduced due to the corrosion resistance effect of the coated mixed conductive protective layer.

Evaluation of Hydrogen Evolution Reaction (HER) Suppression and Corrosion Resistance Enhancement of Zinc Electrodes with or without Application of Mixed Conductive Protective Layer

When the zinc negative electrode in the aqueous zinc secondary battery is in direct contact with water, side reactions such as water decomposition and corrosion may occur at the electrode/electrolyte interface. To evaluate whether such side reactions were mitigated by coating the zinc negative electrode with the mixed conductive protective layer, the three-electrode electrochemical cells of Example 3 and Comparative Example 3 were configured, and the following electrochemical analyses were performed: LSV and Tafel analysis.

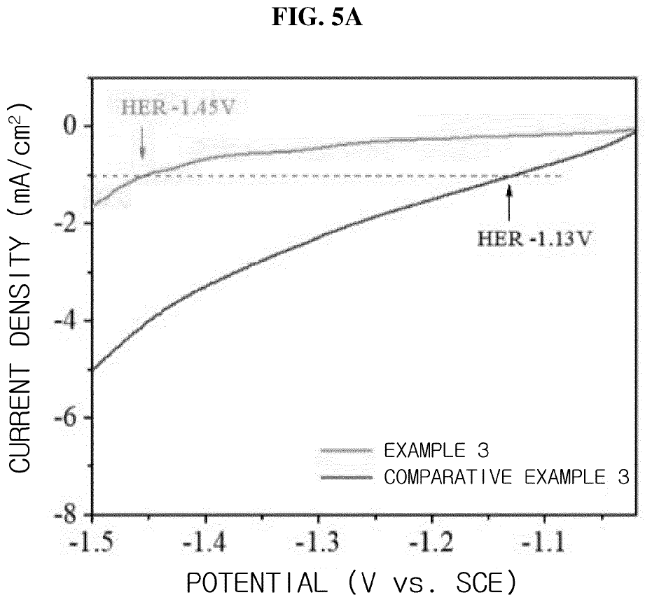

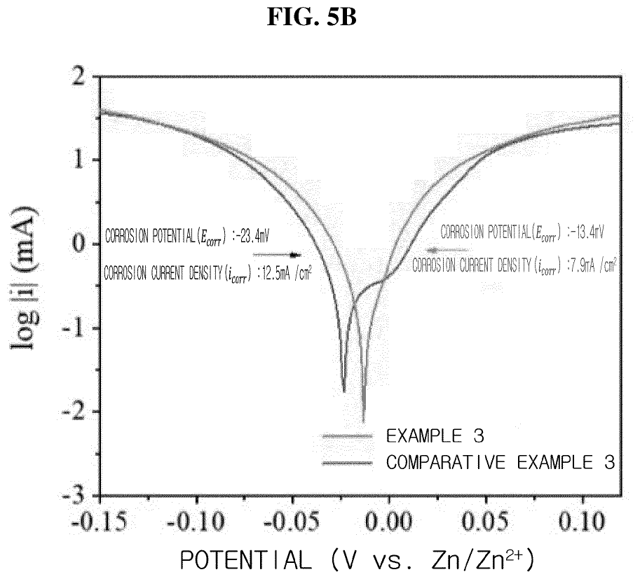

The LSV results are shown in FIG. 5A. Referring to FIG. 5A, at the same hydrogen evolution overpotential, it was confirmed that Comparative Example 1 exhibited an HER at −1.13 V, whereas Example 1 exhibited an HER at −1.45 V. In particular, at the same hydrogen evolution overpotential of −1.45 V, Comparative Example 1 exhibited a current density of −4 mA/cm², whereas Example 1 exhibited a current density of −1 mA/cm². Such a difference confirms that the sample coated with the protective layer suppresses the HER.

The results of the Tafel analysis performed to evaluate corrosion resistance are shown in FIG. 5B. Referring to FIG. 5B, Example 1 exhibited a corrosion current density of 7.9 mA/cm², whereas Comparative Example 1 exhibited a corrosion current density of 12.5 mA/cm². The difference in corrosion current density confirms that the formation of ZHS byproducts due to corrosion was suppressed in Example 1. Such corrosion is mainly driven by the HER and can be seen as resulting from the mixed conductive protective layer restricting the access of water and sulfate ions to the surface of the zinc negative electrode substrate. In addition, Comparative Example 1 exhibited a corrosion potential of −23.4 mV, whereas Example 1 exhibited a corrosion potential of −13.4 mV. The corrosion potential shifted in the positive direction indicates an increase in the HER overpotential, which confirms the corrosion protection function of the mixed conductive protective layer.

### Comparison of In-Situ Deposition Behavior and Surface Morphology of Zinc Electrodes Depending on Presence or Absence of Mixed Conductive Protective Layer

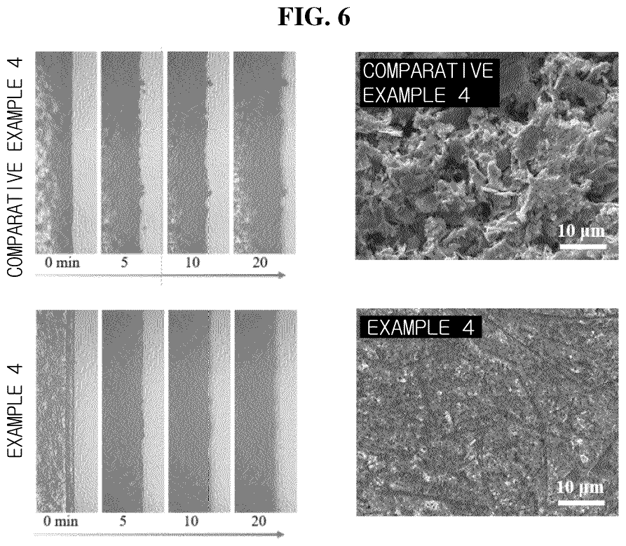

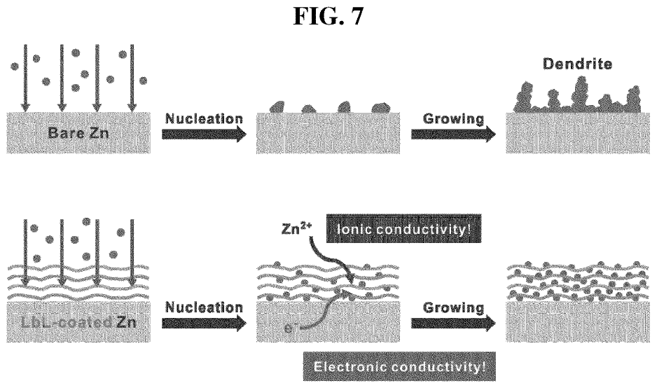

To observe electrochemical deposition behavior in real time depending on the presence or absence of the mixed conductive protective layer, in-situ optical microscopy was performed. To this end, the observation cells of Example 4 and Comparative Example 4, enabling in-situ optical analysis, were fabricated. Example 4 and Comparative Example 4 correspond to observation cells fabricated by applying the zinc electrode coated with the mixed conductive protective layer including 5 bilayers and the zinc electrode without the mixed conductive protective layer, as the respective zinc metal electrodes. For each cell, changes in the electrode surface during zinc deposition were observed over time. The results thereof are shown in FIG. 6. Referring to the images on the left side of FIG. 6, in Comparative Example 4, the formation of non-uniform dendritic zinc, accompanied by the evolution of hydrogen bubbles, was observed from the early stage of deposition.

On the other hand, in Example 4, zinc was deposited in a uniform and dense morphology. This can be seen as resulting from the selective influx of zinc ions and exclusion of activated water molecules by the functional groups of the mixed conductive protective layer, thereby enhancing the efficiency of the zinc deposition reaction.

In addition, the surface morphology after zinc deposition was imaged by SEM. The results thereof are also shown in FIG. 6. Referring to the images on the right side of FIG. 6, the zinc electrode of Comparative Example 4 exhibited a porous and non-uniform surface structure, whereas the zinc electrode of Example 4 maintained a relatively uniform and flat surface and was confirmed to have a high-density fibrous polymer structure. These results are consistent with the results of the in-situ optical observation performed earlier and support the effect of LbL coating in inducing uniform metal growth.

PEDOT:PSS is amphiphilic due to the hydrophobicity of PEDOT and the hydrophilicity of PSS. Due to being amphiphilic as described above, the PEDOT:PSS complex tends to form a helical structure in an aqueous solution. When directly applied to LbL self-assembly coating, such a structure may result in non-uniform polymer deposition in the form of particles on the surface of the zinc negative electrode. To address the problems described above, embodiments of the present disclosure utilize control of polymer and salt concentrations and shear stress.

According to embodiments of the present disclosure, changes in the polymer structure are induced by changing the concentration of the PDDA aqueous solution. In addition, PDDA, which exists in a spherical form in a high-concentration aqueous solution, exists in a linear form when the concentration of the aqueous solution is reduced, thereby enabling the formation of a uniform protective layer, as well as the PEDOT:PSS layer.

According to embodiments of the present disclosure, changes in the polymer structure are induced by controlling the concentration of sodium chloride in the PEDOT:PSS aqueous solution. According to embodiments of the present disclosure, the shielding effect of ions generated by the addition of sodium chloride may be utilized by controlling the concentration of sodium chloride, thereby inducing a linear structural change in PEDOT:PSS and promoting uniform interaction with the PDDA layer.

According to embodiments of the present disclosure, alignment of polymer chains may be promoted through shear stress of a physical fluid, thereby enabling the formation of a denser and more uniform protective layer composed of a fibrous polymer on the first surface of the zinc negative electrode substrate.

According to embodiments of the present disclosure, to obtain shear stress of the fluid during the LbL self-assembly coating process, the zinc negative electrode substrate may be rotated and rotationally immersed in the polymer aqueous solution and deionized water for rinsing. As shear stress acts on the polymer chains in the solution exhibiting fluid-like behavior due to the rotation, the linear chains are aligned, thereby enabling the formation of a high-density fibrous structure.

The embodiments described above are merely illustrative, and various modified embodiments may be made by those skilled in the art based thereon.

Accordingly, the true technical scope of the present disclosure should be determined by the technical idea of the present disclosure described in the appended claims, and should include not only the above-described embodiments but also various modified embodiments.

What is claimed is:

1. A method of manufacturing an aqueous zinc secondary battery to which a mixed conductive protective layer is applied, wherein the aqueous zinc secondary battery comprises: a zinc negative electrode having a first surface coated with a mixed conductive protective layer comprising a plurality of bilayers composed of a poly(diallyldimethylammonium chloride) (PDDA) layer having ionic conductivity and a poly(3,4-ethylenedioxythiophene):polystyrenesulfonate (PEDOT:PSS) layer having electronic conductivity; a positive electrode facing the zinc negative electrode and spaced apart therefrom; a separator disposed between the zinc negative electrode and the positive electrode to prevent a short circuit therebetween; and an electrolyte serving as a medium through which ions move between the zinc negative electrode and the positive electrode,
wherein manufacturing the zinc negative electrode comprises:
pretreating a zinc negative electrode substrate; and
forming, on a first surface of the pretreated zinc negative electrode substrate, a mixed conductive protective layer comprising a plurality of bilayers composed of a PDDA layer having ionic conductivity, and a PEDOT:PSS layer having electronic conductivity by a layer-by-layer (LbL) self-assembly coating method using a PDDA aqueous solution and a PEDOT:PSS aqueous solution.

2. The method of claim 1, wherein the PDDA aqueous solution and the PEDOT:PSS aqueous solution have concentrations of 1 mg/mL or more and 5 mg/mL or less, respectively, and weight-average molecular weights (Mw) in a range of 200,000 to 350,000 and in a range of 50,000 to 100,000, respectively, and
each of the PDDA and PEDOT:PSS aqueous solutions contains 0.10 M or less of sodium chloride.

3. The method of claim 1, wherein the pretreating of the zinc negative electrode substrate comprises:
cleaning the zinc negative electrode substrate;
taping a second surface of the zinc negative electrode substrate; and
treating the first surface of the taped zinc negative electrode substrate with oxygen plasma for surface modification.

4. The method of claim 1, wherein the forming of the mixed conductive protective layer comprises:
rotationally immersing the zinc negative electrode substrate in the PDDA aqueous solution; and
rotationally immersing the zinc negative electrode substrate in the PEDOT:PSS aqueous solution, wherein the rotationally immersing of the zinc negative electrode substrate in the PDDA aqueous solution and in the PEDOT:PSS aqueous solution are sequentially performed multiple times.

5. An aqueous zinc secondary battery to which a mixed conductive protective layer is applied, the aqueous zinc secondary battery comprising:
a zinc negative electrode;
a positive electrode facing the zinc negative electrode and spaced apart therefrom;
a separator disposed between the zinc negative electrode and the positive electrode to prevent a short circuit therebetween; and
an electrolyte serving as a medium through which ions move between the zinc negative electrode and the positive electrode,
wherein the zinc negative electrode comprises:
a zinc negative electrode substrate; and
a mixed conductive protective layer formed on a first surface of the zinc negative electrode substrate, the mixed conductive protective layer comprising a plurality of bilayers composed of a PDDA layer having ionic conductivity and a PEDOT:PSS layer having electronic conductivity.

6. The aqueous zinc secondary battery of claim 5, wherein each bilayer has a thickness in a range of 1 to 100 nm, and
the mixed conductive protective layer has 5 to 10 bilayers.

7. The aqueous zinc secondary battery of claim 5, wherein the mixed conductive protective layer is composed of a fibrous polymer and has a uniform porous surface, and
the aqueous zinc secondary battery suppresses dendrite growth and side reactions and has ionic and electronic conductivity.

8. The aqueous zinc secondary battery of claim 5, wherein the positive electrode contains zinc, and
the positive electrode maintains a voltage range of −0.02 to +0.02 V relative to a reference voltage in a cycle performance test performed on a symmetric cell for up to 1800 hours.

9. The aqueous zinc secondary battery of claim 5, wherein the positive electrode contains manganese dioxide, and
the positive electrode has a capacity retention rate of greater than 66.1% and not exceeding 81.8% of an initial areal capacity after 100 cycles in a cycle performance test performed on a full cell, and a capacity retention rate of greater than 53.9% and not exceeding 71.1% of the initial areal capacity after 200 cycles.
